(19) United States
(12) Patent Application Publication
(10) Pub. No.: US 2026/0110924 A1
(43) Pub. Date: Apr. 23, 2026

(54) SILICON MODULATOR WITH LATERAL CAPACITANCE STRUCTURE

(71) Applicant: CHONGQING UNIVERSITY OF POSTS AND TELECOMMUNICATIONS, Chongqing (CN)

(72) Inventor: Yi HUANG, Chongqing (CN)

(73) Assignee: CHONGQING UNIVERSITY OF POSTS AND TELECOMMUNICATIONS, Chongqing (CN)

(21) Appl. No.: 19/156,868

(22) PCT Filed: Jan. 22, 2025
(86) PCT No.: PCT/CN2025/073841

§ 371 Date: Aug. 14, 2025

(30) Foreign Application Priority Data
Aug. 19, 2024 (CN) 202411135625.9

(51) Int. Cl. G02F 1/025

(52) U.S. Cl. CPC G02F 1/025

(57) ABSTRACT

A silicon modulator with lateral capacitance structure includes, from bottom to top, substrate (3), dielectric layer (2), ridge waveguide (10), capacitive dielectric layer (20), first transparent electrode (108), second transparent electrode (101), first contact metal (130), second contact metal (131), third contact metal (132), fourth contact metal (133), and upper cladding layer (4). Ridge waveguide (10) includes PN junction, P-doped region (105), N-doped region (102), P+ region (106), P++ region (107), N+ region (103), and N++ region (104). First transparent electrode (108) is arranged on upper left side of capacitive dielectric layer (20), and together with capacitive dielectric layer (20), P-doped region (105), P+ region (106), and P++ region (107), forms P-region lateral capacitance structure. Second transparent electrode (101) is arranged on upper right side of capacitive dielectric layer (20), and together with capacitor dielectric layer (20), N-doped region (102), N+ region (103), and N++ region (104), forms N-region lateral capacitance structure. Silicon modulator bandwidth is enhanced according to the technical solution.

### FIELD

The present disclosure relates to the technical field of semiconductors, and in particular to a silicon modulator with a lateral capacitance structure.

### BACKGROUND

A silicon-based optoelectronic apparatus refers to an optoelectronic apparatus that employs silicon as an optical waveguide. The silicon-based optoelectronic apparatus is transparent in a near-infrared band and has important applications in an optical fiber communication system. Since silicon is commonly used as a substrate for an integrated circuit, silicon-based optoelectronics enables integration of optical and electronic devices on a single chip. Such a hybrid apparatus can be manufactured by using conventional semiconductor manufacturing technologies, and provides optical interconnection for faster data transmission between chips and within a chip. Therefore, there are increased interests in silicon-based optoelectronics.

In an optical fiber communication system, a silicon modulator is configured to load electrical signals into an optical domain and is a core device that influences system bandwidth, energy consumption, and signal integrity. A silicon modulator based on plasma dispersion effect implements high-speed modulation through charging and discharging of carriers in a PN junction region. However, since a series resistance of the PN junction limits charging and discharging speed of the PN junction, resulting in low bandwidth of the silicon modulator, corresponding technological improvements are required.

### SUMMARY

In view of this, an object of the present disclosure is to provide a silicon modulator with a lateral capacitance structure to address the issue of improving a bandwidth of a silicon modulator in conventional technologies.

To achieve the above object, the following technical solutions are provided according to the present disclosure.

A silicon modulator with a lateral capacitance structure includes a substrate 3, a dielectric layer 2, a ridge waveguide 10, a capacitive dielectric layer 20, a first transparent electrode 108, a second transparent electrode 101, a first contact metal 130, a second contact metal 131, a third contact metal 132, a fourth contact metal 133, and an upper cladding layer 4. The dielectric layer 2 is arranged on the substrate 3.

The ridge waveguide 10 is arranged on the dielectric layer 2 and the ridge waveguide includes a PN junction, a P+ region 106, a P++ region 107, an N+ region 103, and an N++ region 104. The PN junction includes a P-doped region 105 and an N-doped region 102 adjacent to a right side of the P-doped region. A right side of the P+ region 106 is adjacent to a lower half of a left side of the P-doped region 105. A right side of the P++ region 107 is adjacent to a left side of the P+ region 106. A left side of the N+ region 103 is adjacent to a lower half of a right side of the N-doped region 102. A left side of the N++ region 104 is adjacent to a right side of the N+ region 103.

The capacitive dielectric layer 20 is arranged on the ridge waveguide 10.

The first transparent electrode 108 is arranged on an upper left side of the capacitive dielectric layer 20, and the first transparent electrode 108, together with the capacitive dielectric layer 20, the P-doped region 105, the P+ region 106, and the P++ region 107, forms a P-region lateral capacitance structure. The second transparent electrode 101 is arranged on an upper right side of the capacitive dielectric layer 20, and the second transparent electrode 101, together with the capacitor dielectric layer 20, the N-doped region 102, the N+ region 103, and the N++ region 104, forms an N-region lateral capacitance structure.

The first contact metal 130 is arranged on the P++ region 107. The second contact metal 131 is arranged on the N++ region 104. The third contact metal 132 is arranged on the first transparent electrode 108. The fourth contact metal 133 is arranged on the second transparent electrode 101. Lower halves of the first contact metal 130, second contact metal 131, third contact metal 132, and fourth contact metal 133 are embedded in the upper cladding layer 4.

The upper cladding layer 4 is arranged on the dielectric layer 2. The ridge waveguide 10, the capacitive dielectric layer 20, the first transparent electrode 108, and the second transparent electrode 101 are embedded in the upper cladding layer 4.

Preferably, a radio frequency signal RF is applied between the first contact metal 130 and the second contact metal 131. A direct-current voltage DC1 applied between the first contact metal 130 and the third contact metal 132 is configured for regulating a capacitance formed by the first transparent electrode 108, the capacitive dielectric layer 20, the P-doped region 105, the P+ region 106, and the P++ region 107. An amplitude of the direct-current voltage ranges from 0V to 10V, and the amplitude being 0V indicates that no direct-current voltage is applied between the first contact metal 130 and the third contact metal 132.

A direct-current voltage DC2 applied between the second contact metal 131 and the fourth contact metal 133 is configured for regulating a capacitance formed by the second transparent electrode 101, the capacitive dielectric layer 20, the N-doped region 102, N+ region 103, and N++ region 104. An amplitude of the direct-current voltage ranges from 0V to 10V, and the amplitude being 0V indicates that no direct-current voltage is applied between the second contact metal 131 and the fourth contact metal 133.

Preferably, a thickness h3 of the capacitive dielectric layer 20 ranges from 0 nm to 100 nm, where the thickness h3 being 0 nm indicates that the first transparent electrode 108 and the second transparent electrode 101 are in direct contact with the ridge waveguide 10.

Preferably, a thickness h1 of a slab region of the ridge waveguide 10 is greater than or equal to 0 nm, where the thickness h1 being 0 nm indicates that the ridge waveguide is transitioned into a strip waveguide.

Preferably, a distance w2 between the first transparent electrode 108 and the second transparent electrode 101 ranges from 50 nm to 500 nm.

Preferably, a thickness h4 of the first transparent electrode 108 and the second transparent electrode 101 ranges from 10 nm to 1000 nm. Preferably, the first transparent electrode 108 and the second transparent electrode 101 are made of a transparent conductive oxide material. The first transparent electrode 108 and the second transparent electrode 101 exhibit the following properties within the 1.2 μm to 1.7 μm wavelength range: a refractive index ranging from 1.0 to 2.5, an extinction coefficient ranging from 1×10⁻⁵ to 1×10⁻³, and a resistivity ranging from 1×10⁻⁴ Ω·cm to 1×10⁻² Ω·cm.

Preferably, the dielectric layer 2 is made of a silicon dioxide (SiO₂) material.

Preferably, the ridge waveguide 10 is made of a single-crystal silicon material.

The beneficial effect of the present disclosure is as follows. In the present disclosure, a transparent electrode with high conductivity, a low extinction coefficient, and a low refractive index is connected in parallel with a conventional PN junction series resistor, such that the modulator has a reduced series resistance and an enhanced bandwidth.

The other advantages, objectives, and features of the present disclosure are to be described in the subsequent specification. To some extent, the other advantages, objectives, and features of the present disclosure are apparent to those skilled in the art in view of the following description, or may be taught from the practice of the present disclosure. The objects and other advantages of the present disclosure can be realized and obtained from the following description.

### BRIEF DESCRIPTION OF THE DRAWINGS

In order to make the purpose, technical solutions, and advantages of the present disclosure clearer, a detailed description of preferred embodiments of the present disclosure are provided below in conjunction with the accompanying drawings.

FIG. 1 is a cross-sectional view of a silicon modulator with a lateral capacitance structure;

FIG. 2 is an equivalent circuit diagram of the modulator in FIG. 1;

FIG. 3 shows lateral capacitances of a ridge region of the modulator in FIG. 1, where (a) is for transparent electrode/SiO2/p-Si, and (b) is for transparent electrode/SiO2/n-Si; and

FIG. 4 shows a 3 dB electro-optical bandwidth of the modulator in FIG. 1.

Reference numerals in FIG. 1:

| | | |
|---|---|---|
| 1: upper semiconductor layer, | 2: dielectric layer (insulator), | |
| 3: substrate (semiconductor), | 4: upper cladding layer, | 10: ridge waveguide, |
| 20: capacitive dielectric layer, | 102: N-doped region, | 103: N+ region, |
| 104: N++ region, | 105: P-doped region, | 106: P+ region, |
| 107: P++ region, | 108: first transparent electrode, | |
| 101: second transparent electrode, | 130: first contact metal, | 131: second contact metal, |
| 132: third contact metal, | 133: fourth contact metal, | |

### DETAILED DESCRIPTION OF THE EMBODIMENTS

Hereinafter, the implementation of the present disclosure is illustrated based on specific embodiments. Those skilled in the art may easily understand the other advantages and benefits of the present disclosure from the content disclosed in this specification. The present disclosure may be implemented or applied in other different embodiments. Various details in this specification may be modified or changed according to different viewpoints and applications without departing from the spirit of the present disclosure. It should be noted that the illustrations provided in the following embodiments only illustrate the basic concept of the present disclosure. Without conflict, the following embodiments and the features in the embodiments may be combined with each other.

The accompanying drawings are only used for illustrative purposes and show only schematic diagrams not physical images, which should not be understood as a limitation to the present disclosure. In order to better illustrate the embodiments of the present disclosure, some components in the drawings may be omitted, enlarged or reduced, which do not represent actual sizes of a product. For those skilled in the art, it is understandable that some well-known structures and explanations of these structures in the drawings may be omitted.

The same or similar symbols in the drawings of the embodiments of the present disclosure correspond to the same or similar components. In the description of the present disclosure, it should be understood that the terms, such as “up”, “down”, “left”, “right”, “front” and “back”, indicate orientation or positional relationships based on the orientation or positional relationships shown in the drawings, which are only for the convenience of describing and not for indicating or implying that the device or components referred to must have a specific orientation, be constructed and operated in a specific orientation. Therefore, the terms used to describe the positional relationship in the attached drawings are only for illustrative purposes and cannot be understood as a limitation of the present disclosure. Those skilled in the art can understand the specific meanings of the above terms based on specific situations.

A silicon modulator employing an interferometer such as a Mach-Zehnder interferometer and a ring oscillator serves as an optical modulator. Modulator efficiency, optical insertion loss, and modulation bandwidth are determined by a phase section within the interferometer or the oscillator. A refractive index of the phase section is modified by applying a voltage, which alters electron density and hole density. Modifications of the refractive index enable modifications of intensity and a phase in the output of an interferometer or an oscillator.

The bandwidth of the silicon modulator is affected by a PN junction capacitance Cⱼ and a series resistance Rⱼ, with bandwidth being negatively correlated with Rⱼ and Cⱼ, as shown in the following equation. The bandwidth is more sensitive to variations of Cⱼ. In the conventional technology, the bandwidth of the modulator is increased by reducing Cⱼ, leading to a decrease in the modulation efficiency. Ideally, reducing the series resistance Rⱼ of the PN junction can effectively increase the modulator bandwidth without affecting modulation efficiency.

$${f}_{EO , 3 dB}^{2} \approx \frac{1}{{R}_{j} {C}_{j}^{2}} \frac{0.74}{2 {π}^{2} {Z}_{MOD} {L}_{MOD}}$$

In the above equation, Z_{MOD} is characteristic impedance of a phase shifter of the PN junction of the modulator, and L_{MOD} is a length of the phase shifter.

### Embodiment 1

FIG. 1 is a schematic diagram of a silicon modulator with a transparent electrode according to the embodiment. The modulator according to the present disclosure incorporates improvements over conventional silicon modulators. The modulator according to the present disclosure has various benefits and advantages, including: for example, a transparent electrode with high conductivity, a low extinction coefficient, and a low refractive index is connected in parallel with a conventional PN junction series resistor, such that the modulator has a lower series resistance and a higher bandwidth. As shown in FIG. 1, the modulator is formed on a part of an SOI wafer including a semiconductor substrate 3, a dielectric layer (insulator) 2, and an upper semiconductor layer 1. The modulator further includes a ridge waveguide 10, a capacitive dielectric layer 20, a first transparent electrode 108, a second transparent electrode 101, a first contact metal 130, a second contact metal 131, a third contact metal 132, and a fourth contact metal 133.

The ridge waveguide 10 may be formed by, for example, etching away some parts of the upper semiconductor layer 1. Although sidewalls of the ridge waveguide 10 are depicted as vertical in FIG. 1, it should be noted that, due to semiconductor manufacturing processes, the sidewalls of the ridge waveguide 10 may be slightly rounded or inclined. The ridge waveguide 10 includes a PN junction, and the PN junction includes a P-doped region 105 and an N-doped region 102 adjacent to the P-doped region 105. The ridge waveguide 10 further includes a P+ region 106 adjacent to the P-doped region 105, a P++ region 107 adjacent to the P+ region 106, an N+ region 103 adjacent to the N-doped region 102, and an N++ region 104 adjacent to the N+ region 103.

The first transparent electrode 108 is arranged on an upper left side of the capacitive dielectric layer 20, and the first transparent electrode 108, together with the capacitive dielectric layer 20, the P-doped region 105, the P+ region 106, and the P++ region 107, forms a P-region lateral capacitance structure; and the second transparent electrode 101 is arranged on an upper right side of the capacitive dielectric layer 20, and the second transparent electrode 101, together with the capacitor dielectric layer 20, the N-doped region 102, the N+ region 103, and the N++ region 104, forms an N-region lateral capacitance structure. Under high-frequency signal loading conditions, a current flows from the slab region of the ridge waveguide through the lateral capacitance into the transparent electrode, subsequently reaching the PN junction through the transparent electrode, to form a low-impedance high-frequency pathway, thereby mitigating a microwave dielectric loss.

In the embodiment, the substrate 3 is made of silicon, a silicon-containing material, or another suitable substrate material. The dielectric layer 2 is arranged on the substrate 3. In the embodiment, the dielectric layer 2 is made of a buried oxide (BOX), such as silicon dioxide or another suitable insulator. The upper semiconductor layer 1 is arranged on the dielectric layer 2. In the embodiment, the upper semiconductor layer 1 is made of silicon or another suitable semiconductor material.

In the embodiment, the doping concentration of the P-doped region 105 and the N-doped region 102 is 5×10¹⁷ atoms per cubic centimeter (cm³). The doping concentration of the P+ region 106 and the N+ region 103 is 2×10¹⁸ atoms per cubic centimeter (cm³). The doping concentration of the P++ region 107 and the N++ region 104 is 1×10²⁰ atoms per cubic centimeter (cm³). In the embodiment 1, a thickness h2 of the upper semiconductor layer 1 ranges from approximately 110 nm to approximately 220 nm. A width w1 of the ridge waveguide 10 ranges from approximately 300 nm to approximately 1000 nm.

The capacitive dielectric layer 20 is made of silicon dioxide or another suitable insulator, and is formed through processes such as thermal oxidation or atomic layer deposition. In the embodiment 1, the capacitive dielectric layer 20 is made of thermally oxidized silicon dioxide, with a thickness h3 ranges from 2 nm to 10 nm.

In this embodiment, the thickness of the first transparent electrode 108 and the second transparent electrode 101 ranges from 100 nm to 300 nm, and a distance w2 between the two transparent electrodes ranges from approximately 100 nm to approximately 500 nm. In an embodiment, the first transparent electrode 108 and the second transparent electrode 101 exhibit the following properties within the 1.3 μm and 1.6 μm wavelength range: a refractive index ranging from 1.5 to 2.0, an extinction coefficient ranging from 1×10⁻⁵ to 1×10⁻³, and a resistivity ranging from 1×10⁻⁴ Ω·cm to 1×10⁻³ Ω·cm. In the embodiment 1, the first transparent electrode 108 and the second transparent electrode 101 are transparent conductive oxides (including but not limited to indium tin oxide (ITO), indium tungsten oxide (IWO), indium oxide (IO), indium oxide doped with hydrogen (IOH), indium oxide doped with tungsten and tin (IWTO), indium titanium oxide (ITiO), indium zinc oxide (IZO), aluminum zinc oxide (AZO), tin dioxide doped with tungsten (SnO2: W), zinc oxide (ZnO), and the like).

The first contact metal 130 is arranged on the P++ region 107, the second contact metal 131 is arranged on the N++ region 104, the third contact metal 132 is arranged on the first transparent electrode 108, and the fourth contact metal 133 is arranged on the second transparent electrode 101. In the embodiment 1, the first contact metal 130 and the second contact metal 131 are aluminum, tungsten, or any other material that forms a low-ohmic contact resistance with silicon. The third contact metal 132 and the fourth contact metal 133 are aluminum, tungsten, or any other material that forms a low-ohmic contact resistance with a transparent conductive material.

A radio frequency signal RF is applied between the first contact metal 130 and the second contact metal 131. A direct-current voltage DC1 applied between the first contact metal 130 and the third contact metal 132 is configured for regulating a capacitance formed by the first transparent electrode 108, the capacitive dielectric layer 20, the P-doped region 105, the P+ region 106, and the P++ region 107. In an embodiment, based on a work function of the transparent conductive material and a work function of p-type silicon, the direct-current voltage between the first contact metal 130 and the third contact metal 132 is set to 0V, such that a flat-band large capacitance is obtained. A direct-current voltage DC2 applied between the second contact metal 131 and the fourth contact metal 133 is configured for regulating a capacitance formed by the second transparent electrode 101, the capacitive dielectric layer 20, the P-doped region 102, the P+ region 103, and the P++ region 104. In an embodiment, based on a work function of the transparent conductive material and a work function of n-type silicon, a voltage of −1V is applied between the second contact metal 131 and the fourth contact metal 133, such that an energy band of the n-type silicon at a Si/SiO2 interface is a flat band.

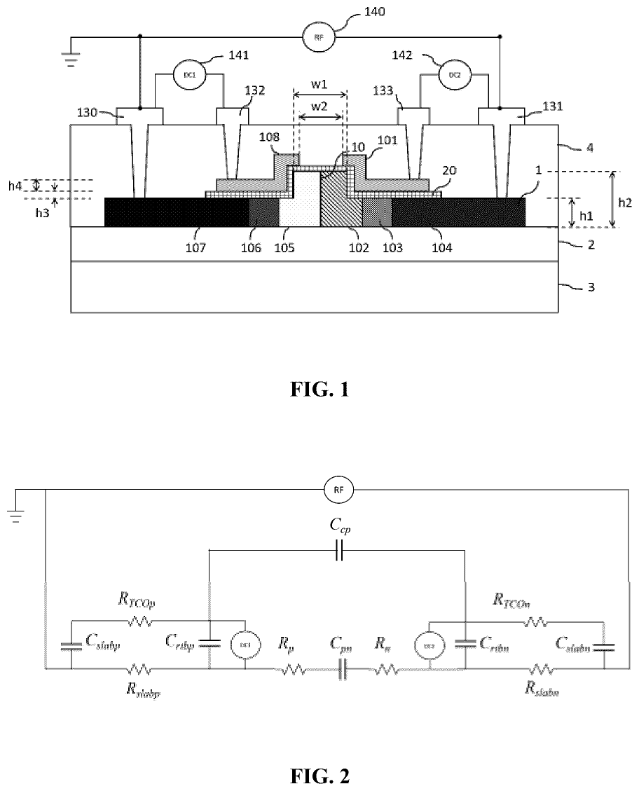

FIG. 2 is an equivalent circuit diagram of the modulator in FIG. 1. Lateral capacitors C_{slab} and C_{rib} provide a high-frequency pathway for a series resistor of the PN junction of the modulator, and this pathway is formed by a low resistor Rico of a transparent electrode, the capacitors C_{slab} and C_{rib}, where the capacitors C_{slab} and C_{rib} are formed by the transparent electrodes, the capacitive dielectric layer, and a doped slab region. In a high-frequency component of a modulation signal, current flows through R_{TCO}, C_{slab} and C_{rib}, to reduce a slab region resistance r_{slab}. Since the slab region resistance constitutes the majority of the total series resistance, the lateral capacitance significantly reduces the overall series resistance, thereby increasing the bandwidth.

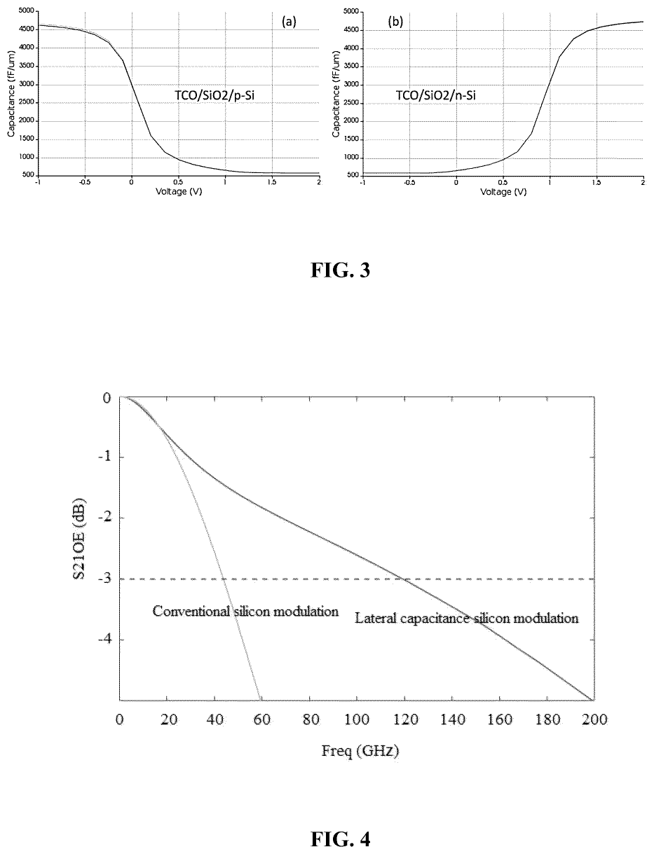

FIG. 3 shows a lateral capacitance C_{rib} of the ridge region in the modulator in FIG. 2. At an appropriate direct-current voltage operation point, the capacitance is greater than 3000 pF/m, which is far greater than the PN junction capacitance of approximately 200 pF/m, ensuring the voltage division of the PN junction. Since a slab region capacitance C_{slab} is far greater than the capacitance C_{rib}, only the capacitance C_{rib} is provided.

FIG. 4 shows the bandwidth of the modulator in FIG. 1. In an embodiment, a thickness of the capacitive dielectric layer is 2 nm, no voltage is applied between the first contact metal 130 and the third contact metal 132, and a voltage of −1V is applied between the second contact metal 131 and the fourth contact metal 133. The 3 dB electro-optical bandwidth is increased from 40 GHz in a conventional structure to 120 GHz.

Although in the present disclosure, some embodiments has been provided. It should be understood that the disclosed system and method may be embodied in many other specific forms without departing from the spirit or scope of the present disclosure. This embodiment is considered illustrative rather than limiting, and the purpose is not to be restricted to the details provided herein. For example, various components or assemblies may be combined or integrated into another system, or specific features may be omitted or not implemented.

Finally, it should be noted that the above embodiments are only used to illustrate rather than limit the technical solutions of the present disclosure. Although the technical solutions have been described in detail with reference to the preferred embodiments, those skilled in the art should understand that modifications or equivalent substitutions may be made to the technical solutions of the present disclosure without departing from the principle and scope of the technical solutions of the present disclosure. All the modifications and equivalent substitutions to the present disclosure fall within the protection scope of the present disclosure.

1. A silicon modulator with a lateral capacitance structure, wherein the silicon modulator comprises a substrate, a dielectric layer, a ridge waveguide, a capacitive dielectric layer, a first transparent electrode, a second transparent electrode, a first contact metal, a second contact metal, a third contact metal, a fourth contact metal, and an upper cladding layer;
the dielectric layer is arranged on the substrate;
the ridge waveguide is arranged on the dielectric layer; the ridge waveguide comprises a PN junction, a P+ region, a P++ region, an N+ region, and an N++ region; the PN junction comprises a P-doped region and an N-doped region adjacent to a right side of the P-doped region; a right side of the P+ region is adjacent to a lower half of a left side of the P-doped region; a right side of the P++ region is adjacent to a left side of the P+ region; a left side of the N+ region is adjacent to a lower half of a right side of the N-doped region; a left side of the N++ region is adjacent to a right side of the N+ region;
the capacitive dielectric layer is arranged on the ridge waveguide;
the first transparent electrode is arranged on an upper left side of the capacitive dielectric layer, and the first transparent electrode, together with the capacitive dielectric layer, the P-doped region, the P+ region, and the P++ region, forms a P-region lateral capacitance structure; the second transparent electrode is arranged on an upper right side of the capacitive dielectric layer, and the second transparent electrode, together with the capacitor dielectric layer, the N-doped region, the N+ region, and the N++ region, forms an N-region lateral capacitance structure;
the first contact metal is arranged on the P++ region; the second contact metal is arranged on the N++ region; the third contact metal is arranged on the first transparent electrode; the fourth contact metal is arranged on the second transparent electrode; and lower halves of the first contact metal, second contact metal, third contact metal, and fourth contact metal are embedded in the upper cladding layer, wherein a radio frequency signal RF is applied between the first contact metal and the second contact metal, a direct-current voltage DC1 applied between the first contact metal and the third contact metal is configured for regulating a capacitance formed by the first transparent electrode, the capacitive dielectric layer, the P-doped region, the P+ region, and the P++ region; and a direct-current voltage DC2 applied between the second contact metal and the fourth contact metal is configured for regulating a capacitance formed by the second transparent electrode, the capacitive dielectric layer, the N-doped region, N+ region, and N++ region; and
the upper cladding layer is arranged on the dielectric layer; and the ridge waveguide, the capacitive dielectric layer, the first transparent electrode, and the second transparent electrode are embedded in the upper cladding layer.

2. The silicon modulator according to claim 1, wherein an amplitude of the direct-current voltage DC1 applied between the first contact metal and the third contact metal ranges from 0V to 10V, and the amplitude being 0V indicates that no direct-current voltage is applied between the first contact metal and the third contact metal; and
an amplitude of the direct-current voltage DC2 applied between the second contact metal and the fourth contact metal ranges from 0V to 10V, and the amplitude being 0V indicates that no direct-current voltage is applied between the second contact metal and the fourth contact metal.

3. The silicon modulator according to claim 1, wherein a thickness h3 of the capacitive dielectric layer ranges from 0 nm to 100 nm, wherein the thickness h3 being equal to 0 nm indicates that both the first transparent electrode and the second transparent electrode are in direct contact with the ridge waveguide.

4. The silicon modulator according to claim 1, wherein a thickness h1 of a slab region of the ridge waveguide is greater than or equal to 0 nm, wherein the thickness h1 being equal to 0 nm indicates that the ridge waveguide is transitioned into a strip waveguide.

5. The silicon modulator according to claim 1, wherein a distance w2 between the first transparent electrode and the second transparent electrode ranges from 50 nm to 500 nm.

6. The silicon modulator according to claim 1, wherein a thickness h4 of the first transparent electrode and the second transparent electrode ranges from 10 nm to 1000 nm.

7. The silicon modulator according to claim 1, wherein the first transparent electrode and the second transparent electrode are made of a transparent conductive oxide material.

8. The silicon modulator according to claim 1, wherein the dielectric layer is made of a silicon dioxide material.

9. The silicon modulator according to claim 1, wherein the ridge waveguide is made of a single-crystal silicon material.

10. The silicon modulator according to claim 5, wherein the first transparent electrode and the second transparent electrode are made of a transparent conductive oxide material.

11. The silicon modulator according to claim 6, wherein the first transparent electrode and the second transparent electrode are made of a transparent conductive oxide material.
